(19) United States
(12) Patent Application Publication
(10) Pub. No.: US 2008/0201889 A1
(43) Pub. Date: Aug. 28, 2008

(54) WINDSCREEN WIPER FOR MOTOR VEHICLES

(76) Inventors: Giuseppe VALDE, Torino (IT); Giovanni CREACO, Alpignano (IT)

Correspondence Address: MERCHANT & GOULD PC, P.O. BOX 2903, MINNEAPOLIS, MN, 55402-0903, US

(21) Appl. No.: 12/031,394

(22) Filed: Feb. 14, 2008

(30) Foreign Application Priority Data
Feb. 27, 2007 (IT) TO2007A000136

(51) Int. Cl. B60S 1/02

(52) U.S. Cl. 15/250.23; 15/250.3; 15/250.351

(57) ABSTRACT

Described herein is a windscreen wiper for motor vehicles of the type made up of: an oscillating arm (3), fitted on the shaft of an electric motor; a blade-holder (5); and a wiper element for cleaning the glass of the windscreen of a motor vehicle; the blade-holder (5) comprises a metal lamina (7), for supporting the rubber wiper element, which is made of spring steel and is arched with a variable radius of curvature according to the radius of curvature of the glass (8) of the windscreen of the motor vehicle on which the windscreen wiper is mounted.

The present invention relates to a windscreen wiper for motor vehicles, in which the blade-holder is made with a metal lamina arched according to the curvature of the windscreen to which it is to be combined.

The windscreen wipers currently available on the market are usually made in three distinct parts. The first is constituted by the oscillating arm connected to an electric motor, the second by the blade-holder designed to enable the necessary elastic flexibility of the ensemble of the windscreen wiper, and the third is constituted by the wiper blade generally made of rubber and with a rigid metal core, which adheres to the windscreen as it is pushed by the blade-holder.

Normally, the blade-holder is made up of a set of arcs, generally three that are connected to one another in their central part according to a one-two arrangement. This arrangement is provided in an attempt to guarantee the same pressure over the entire extension of the wiper, irrespective of the curvature of the windscreen, so that the film of water thereon will be removed in a uniform way.

However, this complex structure, which to a certain extent projects from the windscreen, is impinged upon by the air when the vehicle is travelling and consequently tends to lift up or in any case to reduce the pressure with which it rests on the windscreen, so causing little uniformity in cleaning the glass, which thus presents areas in which the film of water is not removed.

The purpose of the present invention is to provide a windscreen wiper that will not present the aforesaid drawbacks and that at the same time will present low production costs and will be simple to manufacture.

The above purpose is achieved according to the present invention by a windscreen wiper that has a blade-holder with the characteristics specified in claim 1.

Further characteristics and advantages will emerge clearly from the ensuing description, with reference to the attached plates of drawings of a preferred embodiment of the invention, which are provided by way of non-limiting example and in which:

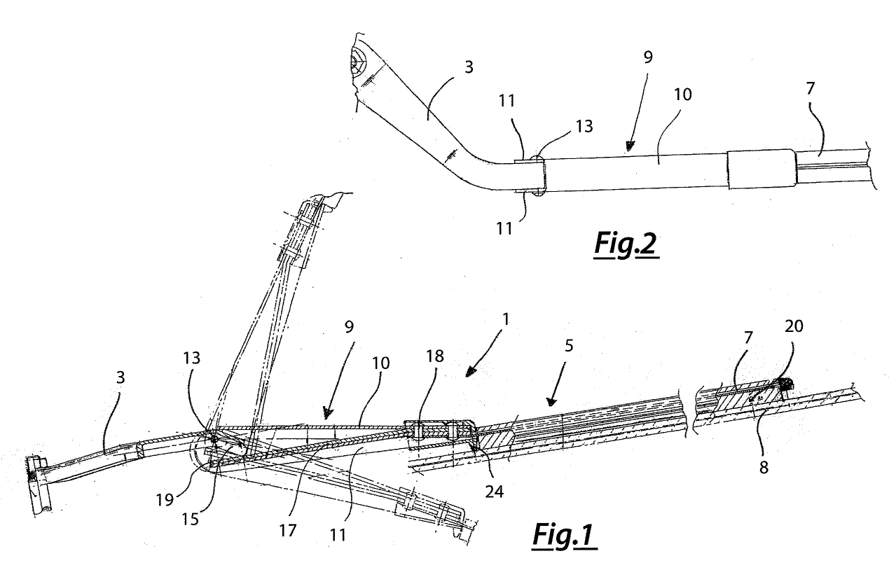

FIG. 1 is a partially cross-sectional side view of the windscreen wiper according to the invention, shown resting on the windscreen of the motor vehicle and in two operative positions, indicated by dashed lines;

FIG. 2 is a view from above of the windscreen wiper of FIG. 1;

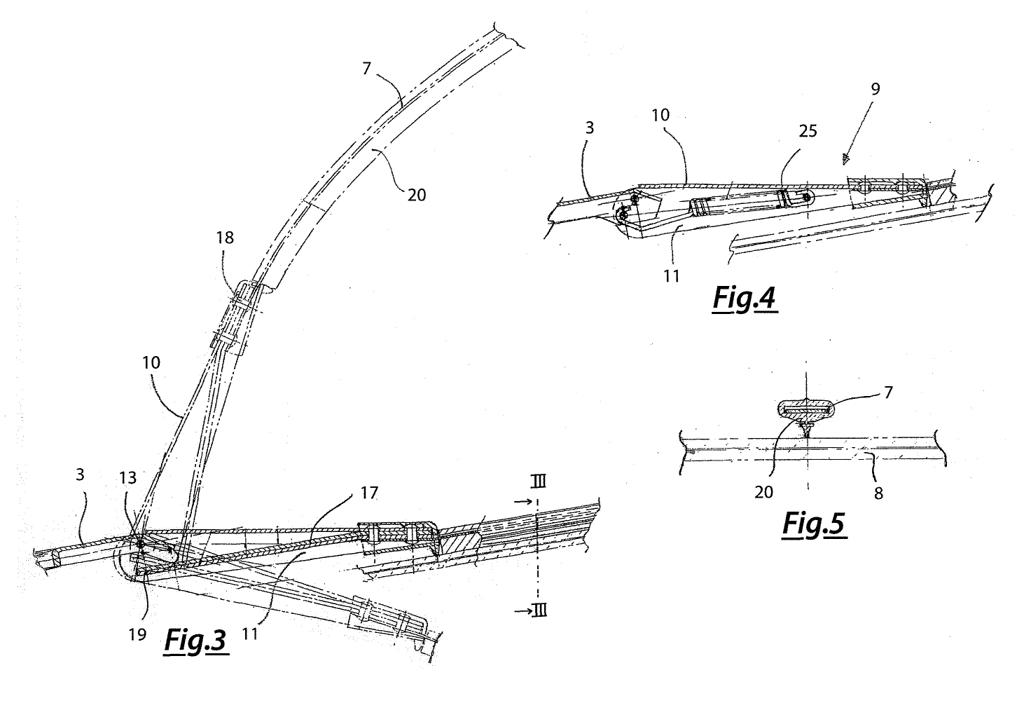

FIG. 3 is a partially cross-sectional side view, as in FIG. 1, of the windscreen wiper of the invention shown resting on the windscreen of the motor vehicle and in two operative positions indicated by dashed lines, clearly visible in one of which is the arched shape of the blade-holder;

FIG. 4 is a partial, cross-sectional side view of a second embodiment of the elastic connection between the blade-holder and the oscillating arm of the windscreen wiper;

FIG. 5 is a cross-sectional view of the blade-holder according to the line III-III of FIG. 3;

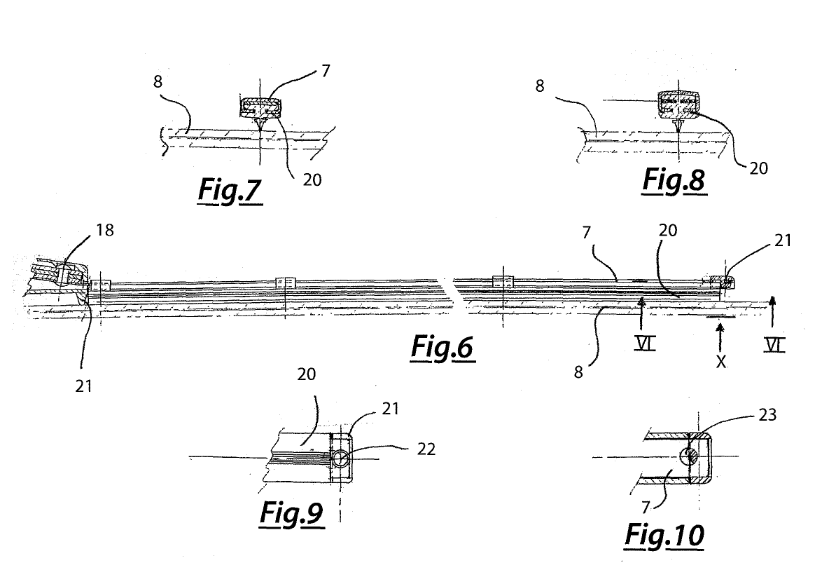

FIG. 6 is a partial side view of a blade-holder according to another preferred embodiment of the invention;

FIGS. 7 and 8 are cross sections taken on the blade-holder of FIG. 6;

FIG. 9 is a partial view from X of the end detent of the wiper element of FIG. 6; and

FIG. 10 is a cross-sectional view according to the line VI-VI of the detent of the wiper element of FIG. 6.

With reference to the figures, designated as a whole by 1 is a windscreen wiper for motor vehicles formed by an arm 3 fitted on the shaft of an electric motor (not illustrated) and by a blade-holder or stem 5. The blade-holder or stem is formed by a metal lamina 7 made of spring steel, which is arched with a variable radius of curvature according to the radius of curvature of the glass 8 of the windscreen of the model of vehicle on which it will be required to operate.

The metal lamina 7 is connected, with one of its ends, to the arm 3 of the windscreen wiper via an elastic element 9 for connection made up of a shell 10, which has a top wall and two sides 11, which are connected in rotation via a pin 13 to the arm 3 in a point corresponding to the start of the free end 15 of said arm, which is curved by some degrees downwards, i.e., in the direction of the windscreen 8. The two sides 11 enclose at least one elastic metal lamina 17, in the case illustrated two, which are made of spring steel and are joined in a single pack, via rivets 18, at the end of the metal lamina 7, whilst the other ends 19 are located under the curved free end 15, so as to pinch it between them and the terminal part of the top wall of the shell 9. In this way, an elastic connection is made with the arm 3, which tends to push the blade-holder against the glass 8 of the windscreen.

Fitted on the metal lamina 7, via a longitudinal cavity, is a wiper element 20 (FIG. 5) normally made of rubber. The wiper element 20 is withheld on the metal lamina via a detent 21 by means of a tooth 22 inserted by snap action in a hole 23 made on the lamina at the free end not connected to the elastic element 9.

In a position corresponding to its connection to the blade-holder, the elastic element 9 bears a lug 24, which, in use, rests on the glass of the windscreen to prevent squeezing of the rubber part of said blade-holder.

The windscreen wiper thus provided is of very simple construction, constitutes a minimum impediment to the visibility of the driver and, given that it has a very small surface, its action is affected to a very reduced extent by the air that flows across the windscreen of the vehicle when the latter is moving.

FIG. 4 illustrates a variant embodiment of the elastic connection between the oscillating arm 3 and the blade-holder 5, in which the bottom elastic laminas are replaced by a spring 25 that works in extension and is connected at the bottom to the arm 3 and to the blade-holder 5. Said spring performs the same functions of compression of the blade-holder 5 on the glass of the windscreen of the motor vehicle.

FIGS. 6 to 8 illustrate an alternative embodiment of the blade-holder 5, which has the rubber wiper element with a different profile having another type of engagement to the metal lamina 7.

It should be noted, however, that also other forms of connection of a known type may be used, without thereby departing from the sphere of protection defined by the claims annexed to the present patent application.

1. A windscreen wiper for motor vehicles comprising: an oscillating arm fitted on the shaft of an electric motor; a connection element between the arm and a blade-holder; and a wiper element for cleaning the glass of the windscreen of a motor vehicle, wherein the blade-holder comprises a metal lamina connected with one end to the connection element and has the function of supporting the rubber wiper element; said metal lamina being made of spring steel and being arched with a variable radius of curvature according to the radius of curvature of the glass of the windscreen of the motor vehicle on which the windscreen wiper is mounted.

2. The windscreen wiper for motor vehicles according to claim 1, wherein the connection element between blade-holder and arm is an elastic element confiruged to press the blade-holder against the glass of the windscreen.

3. The windscreen wiper according to claim 1, wherein the elastic element is formed by a shell that has a top wall and two sides, connected in rotation via a pin to a free end of the arm, and wherein said two sides enclose at least one elastic metal lamina made of spring steel, joined in a pack to one end of said lamina and of the top wall of the shell, via rivets.

4. The windscreen wiper according to claim 1, wherein the free end of the oscillating arm is curved downwards toward the windscreen.

5. The windscreen wiper according to claim 1, wherein an end of a top wall of the elastic element not connected to the lamina rests on a free end of the oscillating arm, and the free end of the elastic metal lamina not connected to the lamina rests under the free end of the oscillating arm to pinch said end between them.

6. The windscreen wiper according to claim 1, wherein the connection element is formed by a shell that has two side, connected in rotation via a pin to a free end of the arm, and contains a spring, which works in extension and is connected at a bottom to the arm and to the blade-holder.

7. The windscreen wiper according to the claim 1 wherein the elastic element bears a lug, which, in use, rests on the glass of the windscreen so as to prevent squeezing of the rubber part of said blade-holder.
